(19) United States
(12) Patent Application Publication
(10) Pub. No.: US 2022/0174587 A1
(43) Pub. Date: Jun. 2, 2022

(54) Network Slicing Security

(71) Applicant: AT&T Intellectual Property I, L.P., Atlanta, GA (US)

(72) Inventor: Joseph Soryal, Ridgewood, NY (US)

(73) Assignee: AT&T Intellectual Property I, L.P., Atlanta, GA (US)

(21) Appl. No.: 17/105,875

(22) Filed: Nov. 27, 2020

(51) Int. Cl. H04W 48/18; H04W 12/00; H04W 28/02; H04W 76/10; H04L 12/46; G06F 9/455

(52) U.S. Cl. CPC H04W 48/18; H04W 12/0027; H04W 28/0268; G06F 2009/45595; H04L 12/4641; G06F 9/45558; G06F 2009/45562; H04W 76/10

(57) ABSTRACT

A slicing security management system (“system”) can receive, from an application executing on a device, a request to initiate a communications session with an application server. The system can receive information about the communications session. The system can trigger separate notification flows to provide each element participating in the communications session with sub slices and security credentials to be used during the communications session. The system can provide a radio access network and the application with a frequency range and the security credentials to be used for each of the sub slices. The system can instruct a transport network to configure virtual private network routers at each transport network edge. The system can instruct the core network to instantiate a virtual machine for each of the sub slices. The system can synchronize the elements participating in the communications session and can instruct the application to initiate the communications session.

### BACKGROUND

Software-defined networking (“SDN”) is an architectural framework for creating intelligent networks that are programmable, application aware, and more open than traditional hardware-based network architectures. SDN provides an agile and cost-effective communications platform for handling the dramatic increase in data traffic on networks by providing a high degree of scalability, security, and flexibility. SDN provides several benefits. SDN can allow for the creation of multiple virtual network control planes on common hardware. SDN can help extend service virtualization and software control into many existing network elements. SDN enables applications to request and manipulate services provided by the network and to allow the network to expose network states back to the applications. SDN exposes network capabilities through application programming interfaces (“APIs”), making the control of network equipment remotely accessible and modifiable via third-party software clients using open protocols such as OpenFlow, available from Open Network Forum (“ONF”).

User-defined, on-demand cloud services and user digital experience expectations are driving planning and deployment of network function virtualization and service-centric SDN among global telecommunications service providers. Network Virtualization Platforms (“NVPs”) are deployed in information technology (“IT”) data centers, network central offices, and other network points of presence (“POPs”) to accelerate deployment of on-demand user service and virtualized network functions. An NVP is a shared virtualized infrastructure that supports multiple services and network applications/

SDN and NVP enable new network technologies such as network slicing. Network slicing allows mobile network operators to create a set of independent end-to-end logical networks (called “network slices”) that run on a shared physical infrastructure. Each network slice can contain all of the network resources required to provide end-to-end connectivity for a specific network service.

The advent of new and creative ways to enhance network capabilities, such as in the case of network slicing, often exposes vulnerabilities that can be exploited. In current implementations of network slicing, once an attacker recognizes which slice belongs to which service/application, the attacker can target a certain segment of the slice and compromise it by breaking encryption, stealing data, performing targeted denial of service (“DoS”) attacks, and analyzing traffic patterns.

### SUMMARY

Concepts and technologies disclosed herein are directed to network slicing security. According to one aspect of the concepts and technologies disclosed herein, a slicing security management system can include a processor and a memory. The memory can have instructions stored thereon that, when executed by the processor, cause the processor to perform operations. In particular, the slicing security management system can receive, from an application executing on a device, a request to initiate a communications session between the application and an application server. The slicing security management system can receive information about the communications session. The information about the communications session can include any combination of an application type of the application, an expected duration of the communications session, a sensitivity of the application, an expected traffic volume associated with the communications session, a latency requirement of the application, and/or other quality of service (“QoS”) requirement(s). In some embodiments, the slicing security management system can receive the information about the communications session from a radio access network (“RAN”). In some other embodiments, the slicing security management system can receive the information about the communications session from the application server.

The slicing security management system can trigger separate notification flows to provide the elements (e.g., the device executing the application, the RAN element(s), the transport network element(s), and the core network element(s) including the application server) that are participating in the communications session with sub slices and security credentials to be used during the communications session. Each sub slice is part of a logical network that, when combined with other sub slices, provides end-to-end connectivity for a specific network service (e.g., allowing the application to communicate with the application server for the exchange of data).

The slicing security management system can provide the RAN and the application with a frequency range and the security credentials to be used for each of the sub slices. For example, the application may utilize three different sub slices to exchange data with the RAN. Each of these sub slices can operate within a distinct frequency range. The slicing security management system can change, over time, frequency range assigned to each sub slice. In some embodiments, the slicing security management system can provide a frequency range for a blank slice and can instruct the application and/or the RAN to insert dummy data in the blank slice.

The slicing security management system can instruct a transport network operating in communication with the RAN to configure a first virtual private network (“VPN”) router at an edge between the RAN and the transport network. The slicing security management system also can instruct the transport network further operating in communication with a core network to configure a second VPN router at the edge between the transport network and the core network. In some embodiments, the first VPN router and the second VPN router can provide a VPN tunnel for each of the sub slices. Alternatively, VPN routers can be used for each individual VPN tunnel.

The slicing security management system can instruct the core network 112 to instantiate a virtual machine for each of the sub slices. In the example above, the application uses three sub slices. Accordingly, the core network can instantiate one virtual machine for each sub slice. The virtual machines can each run an instance of the application server.

The slicing security management system can synchronize the RAN, the transport network, the core network, and the application server in preparation for conducting the communications session. The slicing security management system can then instruct the application to initiate the communications session.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a block diagram illustrating an existing network slicing configuration.

FIG. 1B is a block diagram illustrating a network slicing security configuration in which aspects of the concepts and technologies disclosed herein can be implemented.

FIG. 2 is a flow diagram illustrating a method for implementing network slicing security, according to an illustrative embodiment of the concepts and technologies disclosed herein.

FIG. 3 is a flow diagram illustrating a method for generating encryption sub keys for sub slices, according to an illustrative embodiment of the concepts and technologies disclosed herein.

FIG. 4 is a diagram illustrating an illustrative computer system capable of implementing aspects of the concepts and technologies disclosed herein.

FIG. 5 is a diagram illustrating an illustrative network capable of implementing aspects of the concepts and technologies disclosed herein.

FIG. 6 is a diagram illustrating an illustrative cloud computing platform architecture capable of implementing aspects of the concepts and technologies disclosed herein.

FIG. 7 is a diagram illustrating an illustrative machine learning system capable of implementing aspects of the concept and technologies disclosed herein.

FIG. 8 is a block diagram illustrating an illustrative mobile device and components thereof capable of implementing aspects of the concepts and technologies disclosed herein.

### DETAILED DESCRIPTION

Concepts and technologies disclosed herein are directed to network slicing security. In current implementations of network slicing, once an attacker recognizes which slice belongs to which service/application, the attacker targets a certain segment of the slice and compromises it by breaking encryption, stealing data, performing targeted DoS attacks, and analyzing traffic patterns. The concepts and technologies disclosed herein enable mobile network operators to hide the association between a slice and a corresponding application that uses the slice. More particularly, instead of assigning a single slice to one application for an entire communications session as in current implementations of network slicing, the concepts and technologies disclosed herein utilize sub slices that can be changed during the communications session to confuse attackers/hackers.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, mobile devices, wireless devices, multiprocessor systems, distributed computing systems, microprocessor-based or programmable consumer electronics, minicomputers, mainframe computers, routers, switches, other computing devices described herein, and the like.

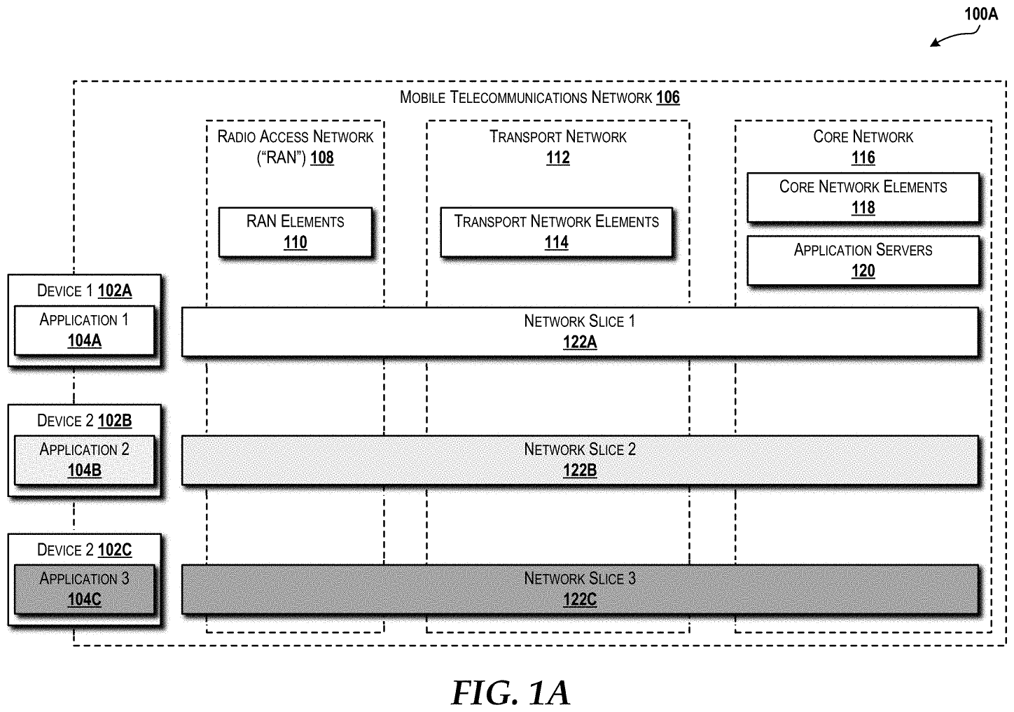

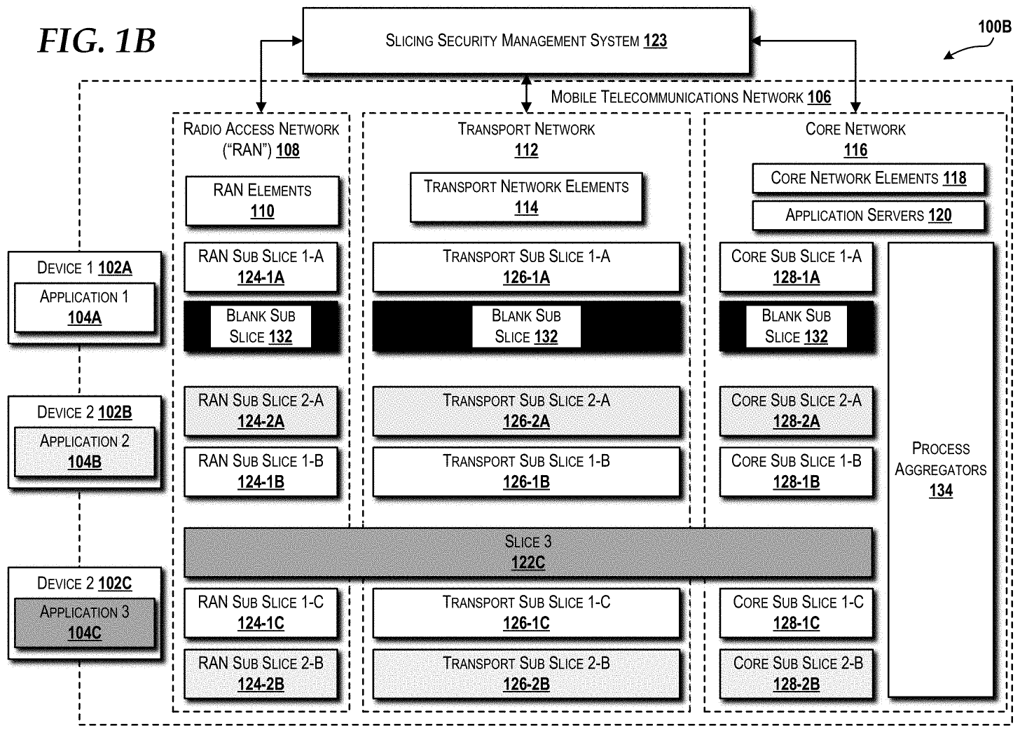

Turning now to FIG. 1A, a block diagram illustrating an example of an existing network slicing configuration 100A will be described. The existing network slicing configuration 100A includes a plurality of devices 102 shown as a device 1 102A, a device 2 102B, and a device 3 102C, each of which can execute a corresponding application 104 shown as an application 1 104A, an application 2 104B, and an application 3 104C, respectively. The devices 102 can operate on and communicate with a mobile telecommunications network 106 that, in turn, can include a radio access network (“RAN”) 108 that contains a plurality of RAN elements 110, a transport network 112 that contains a plurality of transport network elements 114, and a core network 116 that contains a plurality of core network elements 118 and a plurality of application servers 120. The mobile telecommunications network 106 can facilitate communications sessions between the applications 104 executed by the devices 102 and the application servers 120 operating in the core network 116 through independent end-to-end logical networks also known as network slices 122. Each of the network slices 122 can contain network resources from the RAN 108, the transport network 112, and the core network 116 to enable end-to-end connectivity between the applications 104 and the application servers 120. In the illustrated example, a network slice 1 122A corresponds to the application 1 104A, a network slice 2 122B corresponds to the application 2 104B, and a network slice 3 122C corresponds to an application 3 104C.

As mentioned above, an attacker who recognizes which network slice 122 belongs to which application 104 can target a certain segment of the network slice 122 and compromise it by breaking encryption, stealing data, performing targeted DoS attacks, and analyzing traffic patterns. For example, an attacker may attack the RAN elements 110 associated with providing RAN functionality for the network slice 1 122A associated with application 1 104A. Similarly, an attacker may attack the transport network elements 114 associated with providing transport network functionality for the network slice 2 122B associated with application 2 104B. An attacker alternatively may attack the core network elements 118 associated with providing core network functionality for the network slice 3 122C associated with application 3 104C. Any one of these attacks may be successful since the network slices 122 each use a dedicated set of network resources among the RAN 108, the transport network 112, and the core network 116.

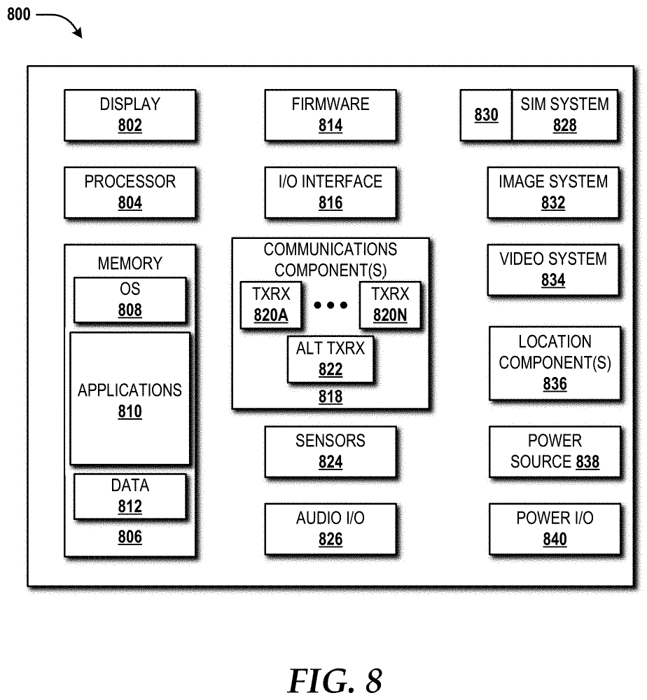

Each of the devices 102 may be referred to as a user equipment (“UE”), cellular phone, a feature phone, a smartphone, a mobile computing device, a tablet computing device, a portable television, a portable video game console, Internet of Things (“IoT”) device, a connected vehicle, a “smart” device, or any other computing device that includes one or more radio access components that are capable of connecting to and communicating with one or more RANs, such as the RAN 108, via one or more radio access components. The devices 102 may include an integrated or external radio access component that facilitates wireless communication with one or more RANs, such as the RAN 108. The radio access component may be a cellular telephone that is in wired or wireless communication with the device(s) 102 to facilitate a tethered data connection to one or more RANs. Alternatively, the radio access component includes a wireless transceiver configured to send data to and receive data from one or more RANs and a universal serial bus (“USB”) or another communication interface for connection to the device(s) 102 so as to enable tethering. In any case, the device(s) 102 can wirelessly communicate with one or more RANs over a radio/air interface in accordance with one or more radio access technologies (“RATs”). The device(s) 102 may also initiate, receive, and maintain voice calls with one or more other voice-enabled telecommunications devices, such as other mobile devices or landline devices (not shown). The device(s) 102 may also exchange Short Message Service (“SMS”) messages, Multimedia Message Service (“MMS”) messages, email, and/or other messages with other devices (not shown). An example mobile device 800 and components thereof is illustrated and described herein with reference to FIG. 8.

The applications 104 can be executed by one or more processing components (best shown in FIG. 8) of the devices 102. The applications 104 can be or can include any application that utilizes, at least in part, network connectivity to communicate with one or more of the application servers 120. The applications 104 can be any type of application, some examples of which include, but are not limited to, productivity applications, web browser applications, video game applications, and creativity applications. The applications 104 can be pre-installed on the devices 102, downloaded and installed on the devices 102, or installed from some media such as an external memory component.

The mobile telecommunications network 106 can operate in accordance with one or more mobile telecommunications standards including, but not limited to, Global System for Mobile communications (“GSM”), Code Division Multiple Access (“CDMA”) ONE, CDMA2000, Universal Mobile Telecommunications System (“UMTS”), Long-Term Evolution, LTE, Worldwide Interoperability for Microwave Access (“WiMAX”), other current 3GPP cellular technologies, other future 3GPP cellular technologies, combinations thereof, and/or the like. It should be noted that the network slices 122 may only be implemented on newer generation technologies that support network slicing, such as 5G technologies and future technologies, and some LTE-based networks. As such, the remaining description will focus on 5G technologies, but this should not be construed as being limiting in any way. As introduced above, the mobile telecommunications network 106 can include the RAN 108, the transport network 112, and the core network 116, each of which will now be described.

The RAN 108 uses radio frequencies to provide wireless connectivity to the devices 102. The RAN 108 can include one or more service areas (also known as “cells”) having the same or different cell sizes, which may be represented by different cell-types. As used herein, a “cell” refers to a geographical area that is served by one or more base stations operating within an access network such as the RAN 108. A “base station” refers to a radio receiver and/or transmitter (collectively, transceiver) that is/are configured to provide a radio/air interface over which the devices 102 can connect to the mobile telecommunications network 106 via the RAN 108. For implementing network slicing functionality, the RAN 108 can be configured in accordance with one or more Third Generation Partnership Project (“3GPP”) technical specifications for next generation (“5G”) RAN architecture, combined 4G/5G RAN architecture, or a revision thereof. As such, the base station may be a next generation node base (“gNodeB”), although some deployments of the gNodeB may include an evolved node base (“eNodeB”) to facilitate backwards compatibility with older technologies that may have better overall coverage in certain areas.

The RAN elements 110 can include one or more gNodeBs. Each gNodeB can include one or more radio components used to generate radio wave to be broadcast by an antenna system. In particular, each gNodeB can include one or more processing units, one or more memory components, one or more baseband units (“BBUs”), one or more remote radio heads (“RRHs”), one or more operating systems, one or more applications, and one or more antenna systems (including antenna arrays and any associated firmware and/or software).

A gNodeB processing unit can process data, execute computer-executable instructions of one or more application programs, and communicate with other components of the gNodeB in order to perform various functionality described herein. The gNodeB processor may be utilized to execute aspects of one or more gNodeB operating systems and one or more gNodeB applications. In some embodiments, a gNodeB processor is or includes a central processing unit (“CPU”), a communications processor, or a field-programmable gate array (“FPGA”). In some embodiments, a gNodeB processor is or is included in a system-on-a-chip (“SoC”) along with one or more of the other components described herein below. For example, the SoC may include a gNodeB processor, one or more BBUs, one or more RRHs, or some combination thereof. In some embodiments, a gNodeB processor is fabricated, in part, utilizing a package-on-package (“PoP”) integrated circuit packaging technique. Moreover, a gNodeB processor may be a single core or multi-core processor. A gNodeB processor may be created in accordance with an ARM architecture, available for license from ARM HOLDINGS of Cambridge, United Kingdom. Alternatively, a gNodeB processor may be created in accordance with an x86 architecture, such as is available from INTEL CORPORATION of Mountain View, Calif. and others. In some embodiments, a gNodeB processor is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an OMAP SoC, available from TEXAS INSTRUMENTS of Dallas, Tex., a customized version of any of the above SoCs, or a proprietary SoC.

A gNodeB memory component can include a random access memory (“RAM”), a read-only memory (“ROM”), an integrated storage memory, a removable storage memory, or some combination thereof. In some embodiments, a gNodeB memory component can store one or more gNodeB operating systems or a portion thereof (e.g., operating system kernel or bootloader), and/or one or more gNodeB applications.

A BBU is the baseband processing unit of a gNodeB. A BBU can include other components, including, for example, one or more gNodeB processors, one or more gNodeB memory component(s), one or more gNodeB operating systems, one or more gNodeB applications, or some combination thereof. A BBU can receive IP packets from the core network 116 via the transport network 112 and can convert the packets into digital baseband signals. A BBU can send the digital baseband signals to one or more RHHs. The digital baseband signals received by the RRH(s) can be demodulated and IP packets can be transmitted to the core network 116 via the transport network 112. An RRH can transmit and receive wireless signals to/from devices such as the device. An RRH also can convert the digital baseband signals received from a BBU that have been subjected to protocol-specific processing into RF signals and power amplifies the signals for transmission to the devices 102. The RF signals received from the devices 102 can be amplified and converted by an RRH to digital baseband signals for transmission to a BBU.

The transport network 112 is a backhaul network that connects the RAN 108 to the core network 116. The transport network 112 can be implemented using different technologies such as copper lines, fiber optics, wireless technologies, or some combination thereof. The transport network 112 can implement virtual private network (“VPN”) technologies to facilitate secure tunneling between the RAN 108 and the core network 116. The transport network elements 114 can include the wireline and/or wireless backhaul elements and supporting infrastructure.

The core network 116 can include a 5G core network, although in some implementations the core network 116 can combine an evolved packet core (“EPC”) with the 5G core network. The core network 116, in turn, can be in communication with one or more other networks (not shown), such as one or more other public land mobile networks (“PLMNs”), one or more packet data networks (“PDNs”) (e.g., the Internet), combinations thereof, and/or the like. The RAN 108 can connect to an EPC of the core network 116 via an S1 interface provided by the transport network 112; and more specifically to a mobility management entity (“MME”) via an S1-MME, and to a serving gateway (“S-GW”) via an S1-U interface. The EPC of the core network 116 can include one or more MMES, one or more S-GWs (which may be combined with one or more packet gateways (“P-GWs”)), and one or more home subscriber servers (“HSSs”). Although not shown individually in the illustrated example, the core network 116 can include these core network elements 118 and may additionally include other network elements not specifically mentioned herein. In general, the core network 116 can be established based upon 3GPP standards specifications.

The core network elements 118 of the EPC network of the core network 116 can be implemented as physical network functions (“PNFs”) having hardware and software components. The core network elements 118 of the EPC network of the core network 116 can additionally or alternatively be provided, at least in part, by virtual network functions (“VNFs”) supported by an underlying SDN/NVP architecture. For example, the core network elements 118 can be realized as VNFs that utilize a unified commercial-of-the-shelf (“COTS”) hardware and flexible resources shared model with the application software for the respective core network components running on one or more virtual machines (“VMs”). Moreover, the core network elements 118 can be embodied as VNFs in one or more VNF pools, each of which can include a plurality of VNFs providing a particular core network function.

An MME can be configured in accordance with 3GPP standards specifications and can perform operations to control signaling traffic related to mobility and security for access to an eNodeB (operating as part of the RAN elements 110 in the RAN 108) via the S1-MME interface. The MME also can be in communication with an HSS via an S6a interface and a combined S/PGW via an S11 interface. These interfaces are defined as part of 3GPP standards specifications.

An SGW and a PGW can be configured in accordance with 3GPP standards specifications. The SGW can provide a point of interconnect between the radio-side (e.g., an eNodeB of the RAN 108) and the EPC network of the core network 116. The SGW can serve devices by routing incoming and outgoing IP packets between the RAN 108 and the core network 116. The PGW interconnects the core network 116 to the other networks (not shown). The PGW routes IP packets to and from the other network(s). The PGW also perform operations such as IP address/prefix allocation, policy control, and charging. The SGW and the PGW can be in communication with the MME via an S11 interface and with the other network(s) via a SGi interface. These interfaces are defined as part of 3GPP standards specifications.

An HSS can be configured in accordance with 3GPP standards specifications. The HSS is a database that contains user-related information for users of devices, such as devices 102. The HSS can provide support functions to the MME for mobility management, call and data session setup, user authentication, and access authorization.

The core network 116 can additionally or alternatively include a 5G core network that can include network functions that provide functionality similar to that of the EPC network for LTE but for 5G technologies such as mmWave. For example, current 3GPP standards define a 5G core network architecture as having an access and mobility management function (“AMF”) that provides mobility management functionality similar to that of an MME in an EPC network; a session management function (“SMF”) that provides session management functionality similar to that of an MME and some of the S/P-GW functions, including IP address allocation, in an EPC network; an authentication server function (“AUSF”) managed subscriber authentication during registration or re-registration with a 5G core network; and user plane function (“UPF”) combines the user traffic transport functions previously performed by the S/P-GW in an EPC network, among others. While 3GPP has defined some of these network functions, these network functions may be split into greater granularity to perform specific functions, may be combined, and/or additional functions may be added by the time a mobile network operator deploys a live 5G network. As such, a 5G core network is intended to encompass any and all 5G core network functions that are currently defined in technical specifications currently available and revisions thereof made in the future.

Turning now to FIG. 1B, a block diagram illustrating a network slicing security configuration 100B in which aspects of the concepts and technologies disclosed herein can be implemented will be described, according to an illustrative embodiment. The illustrated network slicing security configuration 100B includes the devices 102, the applications 104, the mobile telecommunications network 106, the RAN 108, the RAN elements 110, the transport network 112, the transport network elements 114, the core network 116, the core network elements 118, and the application servers 120 illustrated and described above with reference to FIG. 1A. The network slicing security configuration 100B also employs network slicing but with finer granularity using network sub slices that are managed by a slicing security management system 123. The slicing security management system 123 communicates with the applications 104, the RAN 108, the transport network 112, and the core network 116 to assign sub slices (and associated network resources) for the applications 104. In some embodiments, the security management system 123 can leverage an SDN network (not shown), including SDN components such as SDN controllers, to coordinate the deployment and management of VNFs to support the sub slices within the RAN 108, the transport network 112, and/or the core network 116.

The slicing security management system 123 can receive, from one or more of the applications 104 (hereinafter application 104), a request to initiate a communications session with a corresponding one or more of the application servers 120 operating in the core network 116. The application 104 may be instructed to send such requests directly to the slicing security management system 123. Alternatively, the application 104 may send such requests towards the application server 120 and the slicing security management system 123 may intercept such requests. For example, the slicing security management system 123 may utilize one or more probes deployed on the RAN 108, the transport network 112, and/or the core network 116 for this purpose. The slicing security management system 123 can receive information about the communications session from the RAN 108 or the application server 120. The source of this information can be based upon a predetermined configuration. This information can include, for example, an application type, an expected duration of the communications session, a sensitivity of the application (e.g., as related to security), an expected traffic volume, and any latency requirements and/or other quality of service (“QoS”) requirement(s).

The slicing security management system 123 can use separate notification flows to command each element to be used in the communications session with the sub slices and security credentials (e.g., password and encryption keys/sub keys). As used herein, “encryption keys” or “sub keys” are end-to-end (i.e., from the application 104 to the process aggregator 134). Password are for access. As an example, for traffic from the RAN 108 to enter the transport network 112, the RAN 108 must present a password to the transport network 112. Likewise, a router in the transport network 112 would need to present another password to the core network 116 for traffic to then enter the core network 116. For traffic flow towards the devices 102, the RAN 108 would have to present a password to the device 102 to allow traffic to be sent to the device 102. Passwords can be created and disseminated by the slicing security management system 123. The passwords may be static, but to further increase security, the slicing security management system 123 can change the passwords from time to time or continuously. Thus, this concept provides end-to-end encrypted traffic, but requires passwords for the encrypted traffic to traverse from one segment to another (e.g., from a RAN segment to a transport network segment or from a transport network segment to a core network segment).

At the beginning of the communications session, the slicing security management system 123 can communicate with the RAN 108 and the application 104 to command these elements about the number of sub slices and the frequency band of each sub slice. The slicing security management system 123 also will communicate and command the two end routers of the VPN/switches of the transport link and to assign several logical tunnels (sub slices) within the transport network 112. The slicing security management system 123 can provide the RAN 108 with a mapping scheme for frequency bands and VPN tunnels. For example, the mapping scheme may instruct the RAN 108 to create a sub slice (which may be identified by a numeric, alphanumeric, or some other identifier) between the application 104 and the RAN 108 and that sub slice should be stitched to a specific VPN logical link (which also may be identified by a numeric, alphanumeric, or some other identifier) within the transport network 112. The slicing security management system 123 also can instruct the spin up multiple VMs at the core network 116 and each VM can be mapped to each VPN logical link and the slicing security management system 123 can distribute the mapping information.

The slicing security management system 123 can command each element to use different non-adjacent sub slices. The ratio of adjacent sub slices should not be 1:1, meaning that if a RAN sub slice utilizes 10 megahertz (MGHZ), for example, an adjacent transport network sub slice should operate on a different frequency to reduce apparent association. The security credentials can be different for each sub slice. For example, a unique password can be used by the RAN 108 to access the transport network 112, and a different unique password can be used by the transport network 112 to access the core network 116. Accordingly, each sub slice has a set of security credentials provided by the slicing security management system 123. The slicing security management system 123 can change the security credentials over time. The slicing security management system 123 may change security credentials for each new communications session. The slicing security management system 123 may change security credentials during an established communications session.

The slicing security management system 123 can provide the RAN 108 and the application 104 with the frequencies and security credentials to be used for each RAN sub slice 124. Instead of allocating a 100 to 200 HZ frequency range for a single application as in current network slicing implementations, the slicing security management system 123 can assign multiple sub slices in other ranges (e.g., three RAN sub slices 124 with ranges of 100 to 150 HZ, 200 to 240 HZ, and 350 to 360 HZ). The slicing security management system 123 can assign frequency ranges for a certain time period (e.g., the first few minutes of the communications session), and then change the frequency range periodically (e.g., every few minutes) thereafter. Moreover, instead of sending a stream of data (e.g., 1 2 3 4 5 6 7 8 9 0) on a single slice operating between 100 and 200 HZ, a portion of the data (e.g., 1 2 3 4 5) may be sent on a first sub slice operating on a sub band of the frequency range 100 to 200 HZ, another portion of the data (e.g., 6 7 8) may be sent on a second sub slice operating on another sub band of the frequency range 100 to 200 HZ, and yet another portion of the data (e.g., 9 0) may be sent on a third sub slice operating on yet another sub band of the frequency range 100 to 200 HZ. The slicing security management system 123 can accomplish this by securely communicating with the application 104 and the associated device 102 about what frequency will be used for the sub bands, what duration that frequency will be used, and when to switch sub bands. In some embodiments, a software defined radio can be used by the device 102 to accommodate the requests made by the slicing security management system 123. SDN elements (e.g., routers) can utilize the same logic for creating separate resources for each sub slice. In some embodiments, the slicing security management system 123 additionally commands the RAN element(s) 110 and/or the application 104 to generate dummy data to be used on blank sub slices 132 in an effort to confuse potential attackers.

The slicing security management system 123 can instruct the transport network 112 to configure a VPN router (as part of the transport network elements 114) at the edge of the RAN 108 and another VPN router (also as part of the transport network elements 114) at the edge of the core network 116. Following the RAN sub-slicing dynamic model described above, the division of the VPNs can follow suit in terms of changing the VPN tunnels such that each application 104 can be transported on multiple VPN tunnels and these tunnels can be configured to match the RAN bandwidth. These VPN tunnels created for each application 104 can be discarded after a certain time period and rebuilt to follow the dynamic changes in the RAN sub slice allocation for each application 104. In some embodiments, the VPN tunnels used for the same application can be configured to use different protocols and/or parameters to eliminate apparent association of data traffic and to confuse attackers.

The slicing security management system 123 can instruct the core network 116 to instantiate virtual machines (as part of the core network elements 118 and/or the application servers 120) corresponding to the sub slices. After the slicing security management system 123 instructs all of the elements to be used in the communications session, the slicing security management system 123 can synchronize the elements prior to the application 104 initiating the communications session.

In the illustrated embodiment, the core network 116 includes one or more process aggregators 134. The slicing security management system 123 uses the process aggregators 134 to collect sub slice information at the core network elements 118 level. The core network elements 118 do not know the association of the sub slices. The process aggregators 134 know these associations and aggregate the processes for the final destination. For example, the slicing security management system 123 can create three sub slices on the core network 116 (as three VMs) that correspond to one full application 104. The core network 116 can include many VMs for all applications, but these particular VMs do not know this association (e.g., which group of VMs is dedicated to which application) and the process aggregators 134 do know this association. The process aggregators 134 share this information with the slicing security management system 123. The process aggregators 134 collect the data/traffic from the three VMs and combines the data/traffic into one data stream prior to forwarding the data stream to the appropriate application server 120.

The process aggregators 134 can mirror the application servers 120 in functionality but provide tighter control regarding access since the application servers 120 may be connected to many other elements and may have a long list of authorized users/administrators. The process aggregators 134, on the other hand, utilize strict permissions in terms of who can access data. It should be understood that mirroring the actual application server 120 is a logical division of functionality. For example, the application server 120 may have three main functions: credit card processing, inventory display, and product description. In this example, the process aggregators 134 can create three VMs to represent these functions. The slicing security management system 123 (in collaboration with the process aggregators 134) can attempt to make the application 104 send each stream (e.g., credit card processing, inventory display, and product description) on different sub slices. It should be noted that “mirroring” is best effort and may not be achievable or event applicable in all cases, but in the case that the processor aggregators 134 and the slicing security management system 123 can differentiate among separator functions, mirroring can be used. Otherwise, the core network 116 can utilizes multiple VMs equal to the number of sub slices created in a random manner.

The illustrated example shows each application being associated with sub slices for the RAN 108, the transport network 112, and the core network 116. These sub slices are referenced as RAN sub slices 124, transport sub slices 126, and core sub slices 128, respectively. More particularly, the application 1 104A is associated a RAN sub slice 1-A 124-1A, a RAN sub slice 1-B 124-1B, a RAN sub slice 1-C 124-1C, a transport sub slice 1-A 126-1A, a transport sub slice 1-B 126-1B, a transport sub slice 1-C 126-1C, a core sub slice 1-A 128-1A, a core sub slice 1-B 128-1B, and a core sub slice 1-C 128-1C. The application 2 104B is associated with a RAN sub slice 2-A 124-2A, a RAN sub slice 2-B 124-2B, a transport sub slice 2-A 126-2A, a transport sub slice 2-B 126-2B, a core sub slice 2-A 128-2A, and a core sub slice 2-B 128-1B. The application 3 104C uses the same slice 3 122C introduced above with reference to FIG. 1A.

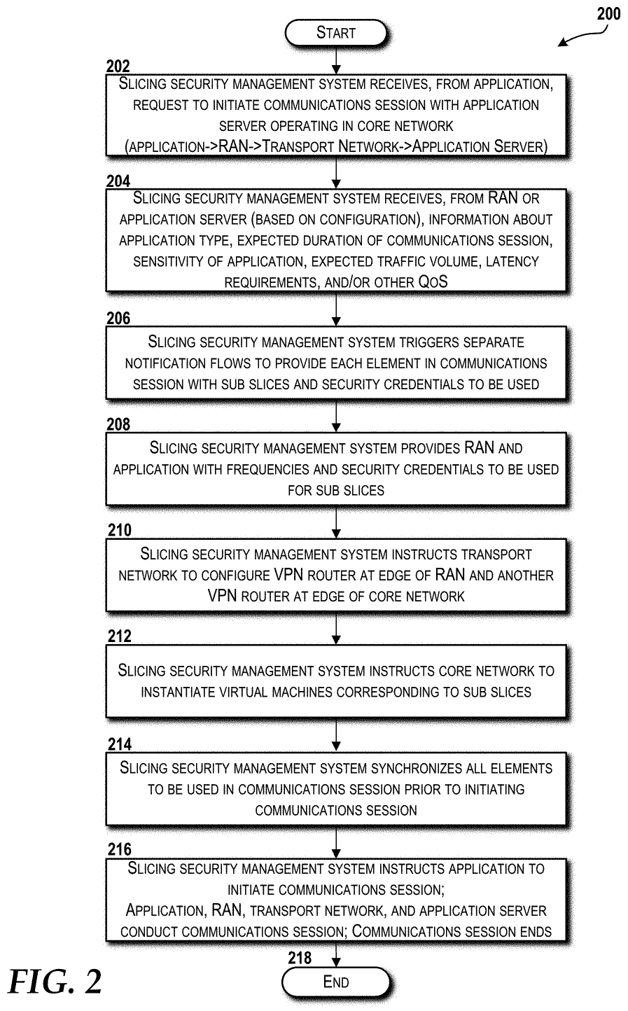

Turning now to FIG. 2, aspects of a method 200 for implementing network slicing security will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the illustrated methods can be ended at any time and need not be performed in their entirety. Some or all operations of the methods, and/or substantially equivalent operations, can be performed by execution of computer-executable instructions included on a computer-readable storage media, as defined below. The term “computer-executable instructions,” and variants thereof, as used in the description and claims, is used expansively herein to include routines, application programs, software, application modules, program modules, components, data structures, algorithms, and the like. Computer-executable instructions can be implemented on various system configurations, including single-processor or multiprocessor systems, distributed computing systems, minicomputers, mainframe computers, personal computers, hand-held computing devices, microprocessor-based, programmable consumer electronics, network nodes, combinations thereof, and the like.

Thus, it should be appreciated that the logical operations described herein may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The method 200 will be described with reference to FIG. 2 and further reference to FIG. 1B. Operations will be described as being performed, at least in part, by one or more of the applications 104 executed by one or more of the devices 102, the slicing security management system 123, one or more of the RAN elements 110 of the RAN 108, one or more of the transport network elements 114 of the transport network 112, one or more of the core network elements 118 of the core network 116, and/or one or more of the application servers 120. Moreover, aspects of the method 200 will be described from the perspective of a single application 104 and sub slices associated with that application 104. It is contemplated that multiple instances of the method 200 can be performed in parallel to accommodate multiple applications 104. As such, the single application 104 embodiment described in FIG. 2 should not be construed as being limiting in any way.

The method 200 begins and proceeds to operation 202. At operation 202, the slicing security management system 123 receives, from an application 104, a request to initiate a communications session with a corresponding application server 120 operating in the core network 116. The application 104 may be instructed to send such requests directly to the slicing security management system 123. Alternatively, the application 104 may send such requests towards the application server 120 and the slicing security management system 123 may intercept such requests. For example, the slicing security management system 123 may utilize one or more probes deployed on the RAN 108, the transport network 112, and/or the core network 116 for this purpose.

From operation 202, the method proceeds to operation 204. At operation 204, the RAN 108 or the application server 120, based upon predetermined configuration, can provide the slicing security management system 123 with information about the communications session. This information can include, for example, an application type, an expected duration of the communications session, a sensitivity of the application (e.g., as related to security), an expected traffic volume, and any latency requirements and/or other quality of service (“QoS”) requirement(s).

From operation 204, the method 200 proceeds to operation 206. At operation 206, the slicing security management system 123 triggers separate notification flows to command each element in the communications session with the sub slices and security credentials (e.g., password) to be used. RAN sub-slicing, transport network sub-slicing, and core network sub-slicing will be described separately in the following operations. It should be understood that these operations may be performed in parallel rather than sequentially as described. Briefly, the slicing security management system 123 can command each element to use different non-adjacent sub slices. The ratio of adjacent sub slices should not be 1:1, meaning that if a RAN sub slice utilizes 10 megahertz (MGHZ), for example, an adjacent transport network sub slice should operate on a different frequency to reduce apparent association. The security credentials can be different for each sub slice. For example, a unique password can be used by the RAN 108 to access the transport network 112, and a different unique password can be used by the transport network 112 to access the core network 116. Accordingly, each sub slice has a set of security credentials provided by the slicing security management system 123. The slicing security management system 123 can change the security credentials over time. The slicing security management system 123 may change security credentials for each new communications session. The slicing security management system 123 may change security credentials during an established communications session.

From operation 206, the method 200 proceeds to operation 208. At operation 208, the slicing security management system 123 provides the RAN 108 and the application 104 with the frequencies and security credentials to be used for each sub slice. Instead of allocating a 100 to 200 HZ slice for a single application 104 as in current network slicing implementations, the slicing security management system 123 can assign multiple sub slices in other ranges (e.g., three sub slices with ranges of 100 to 150 HZ, 200 to 240 HZ, and 350 to 360 HZ). The slicing security management system 123 can assign frequency ranges for a certain time period (e.g., the first few minutes of the communications session), and then change the frequency range periodically (e.g., every few minutes) thereafter. Moreover, instead of sending a stream of data (e.g., 1 2 3 4 5 6 7 8 9 0) on a single slice operating between 100 and 200 HZ, a portion of the data (e.g., 1 2 3 4 5) may be sent on a first sub slice operating on a sub band of the frequency range 100 to 200 HZ, another portion of the data (e.g., 6 7 8) may be sent on a second sub slice operating on another sub band of the frequency range 100 to 200 HZ, and yet another portion of the data (e.g., 9 0) may be sent on a third sub slice operating on yet another sub band of the frequency range 100 to 200 HZ. The slicing security management system 123 can accomplish this by securely communicating with the application 104 and associated device 102 about what frequency will be used for the sub bands, what duration that frequency will be used, and when to switch sub slices. In some embodiments, a software defined radio can be used by the device 102 to accommodate the requests made by the slicing security management system 123. SDN elements (e.g., routers) can utilize the same logic for creating separate resources for each sub slice. In some embodiments, the slicing security management system 123 additionally commands the RAN element(s) 110 and/or the application 104 to generate dummy data to be used on the blank sub slice(s) 132 in an effort to confuse potential attackers.

From operation 208, the method 200 proceeds to operation 210. At operation 210, the slicing security management system 123 instructs the transport network 112 to configure a VPN router at the edge of the RAN 108 and another VPN router at the edge of the core network 116. Following the RAN sub-slicing dynamic model described above, the division of the VPNs will follow suit in terms of changing the VPN tunnels such that each application 104 can be transported on multiple VPN tunnels and these tunnels can be configured to match the RAN bandwidth. These VPN tunnels created for each application 104 can be discarded after a certain time period and rebuilt to follow the dynamic changes in the RAN sub slice allocation for each application 104. In some embodiments, the VPN tunnels used for the same application can be configured to use different protocols and/or parameters to eliminate apparent association of data traffic and to confuse attackers.

From operation 210, the method 200 proceeds to operation 212. At operation 212, the slicing security management system 123 instructs the core network 116 to instantiate virtual machines corresponding to the sub slices. From operation 212, the method 200 proceeds to operation 214. At operation 214, the slicing security management system 123 synchronizes all elements to be used in the communications session prior to instructing the application 104 to initiate the communications session.

In some embodiments, the synchronization process can entail the following. Each segment knows its sub slice (i.e., a frequency range for the RAN 108 and the application 104, the spectrum/pipe for the transport network 112, segment of the core network elements 118 for the VM(s) in the core network 116). Each segment knows the password to provide data traffic to the adjacent segment(s). End-to-end encryption is in place and data can be encrypted/decrypted successfully. The process aggregators 134 are aware of the core sub slices and can aggregate output from the core sub slices. Each segment is ready to accept new direction for sub slices (e.g., frequencies, VMs, etc.). This is achievable via establishing coordination between the different parts and the slicing security management system 123.

From operation 214, the method 200 proceeds to operation 216. At operation 216, the slicing security management system 123 instructs the application 104 to initiate the communications session. Also at operation 216, the application 104, the RAN 108, the transport network 112, and the application server 120 conduct the communications session and the communications session eventually ends.

From operation 216, the method 200 proceeds to operation 218. The method 200 can end at operation 218.

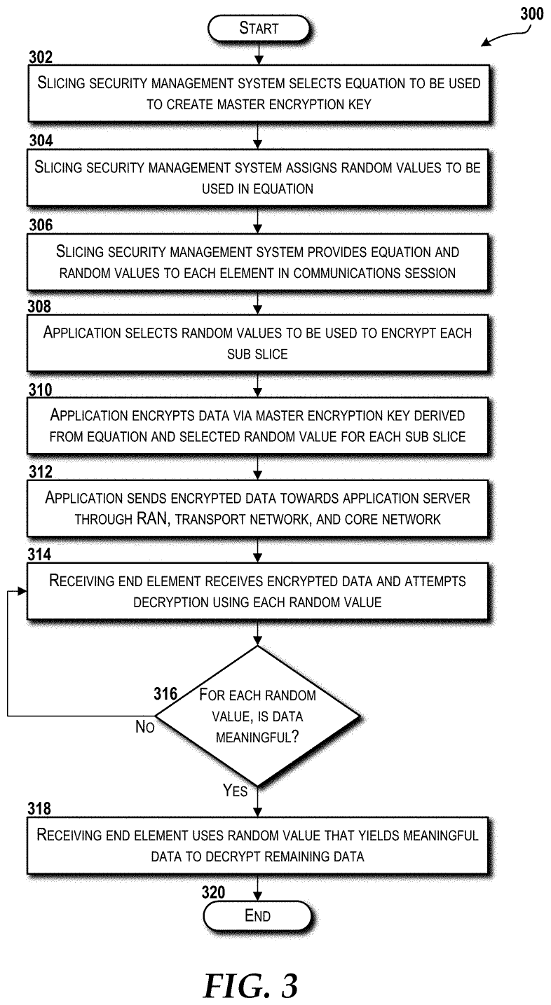

Turning now to FIG. 3, a flow diagram illustrating a method 300 for generating encryption for sub slices (also referred to herein as “sub keys”) will be described, according to an illustrative embodiment of the concepts and technologies disclosed herein.

The method 300 begins and proceeds to operation 302. At operation 302, the slicing security management system 123 selects an equation to be used to create a master encryption key. The slicing security management system 123 can select the equation on a per application basis. The slicing security management system 123 can select the equation automatically based upon one or more preferences established, for example, by a system administrator based upon the sensitivity of the application 104. The slicing security management system 123 also can select the equation responsive to input received from the system administrator.

From operation 302, the method 300 proceeds to operation 304. At operation 304, the slicing security management system 123 assigns random values to be used in the equation. From operation 304, the method 300 proceeds to operation 306. At operation 306, the slicing security management system 123 provides the selected equation and assigned random values to each element participating in the communications session. In particular, the slicing security management system 123 can provide the selected equation and the assigned random values to the application that requested the communications session, the RAN element(s) 110 that provide the air/radio interface for the corresponding device that executes the application 104, the transport network element(s) 114 that connect the RAN 108 to the core network 116, the core network element(s) 118, and the application server(s) 120.

From operation 306, the method 300 proceeds to operation 308. At operation 308, for each sub slice, the application 104 selects a random value from the random values assigned by the slicing security management system 123. At this point, each network element knows the equation and the random values assigned by the slicing security management system 123, but none of the network elements know which random value was selected by the application. From operation 308, the method 300 proceeds to operation 310. At operation 310, the application 104 encrypts data via the master encryption key that is derived from the equation and the selected random value for each sub slice. From operation 310, the method 300 proceeds to operation 312. At operation 312, the application sends the encrypted data towards the application server 120 through the RAN 108, the transport network 112, and the core network 116.

From operation 312, the method 300 proceeds to operation 314. At operation 314, the receiving end element (e.g., the application server 120 or the process aggregator(s) 134 as the case may be) receives the encrypted data via the sub slices and attempts to decrypt the encrypted data using each of the random values. In some embodiments, the receiving end element can incorporate machine learning technologies to expedite this process. From operation 314, the method 300 proceeds to operation 316. At operation 316, the receiving end element determines, for each random value, if the decrypted data is meaningful. As used herein, “meaningful” data is data that includes a word or value that is recognizable (e.g., 1, 6, moon, sun, house, etc.) as opposed to unrecognizable (e.g., GJDJKJ5J5JJK5_)(*) If not, the method 300 returns to operation 314 and the receiving end element attempts the next random value. This process repeats until the receiving end element determines the random value that yields meaningful data, at which point the method 300 proceeds to operation 318. At operation 318, the receiving end element uses the random value that yields meaningful data to decrypt the remaining data. From operation 318, the method 300 proceeds to operation 320. The method 300 can end at operation 320.

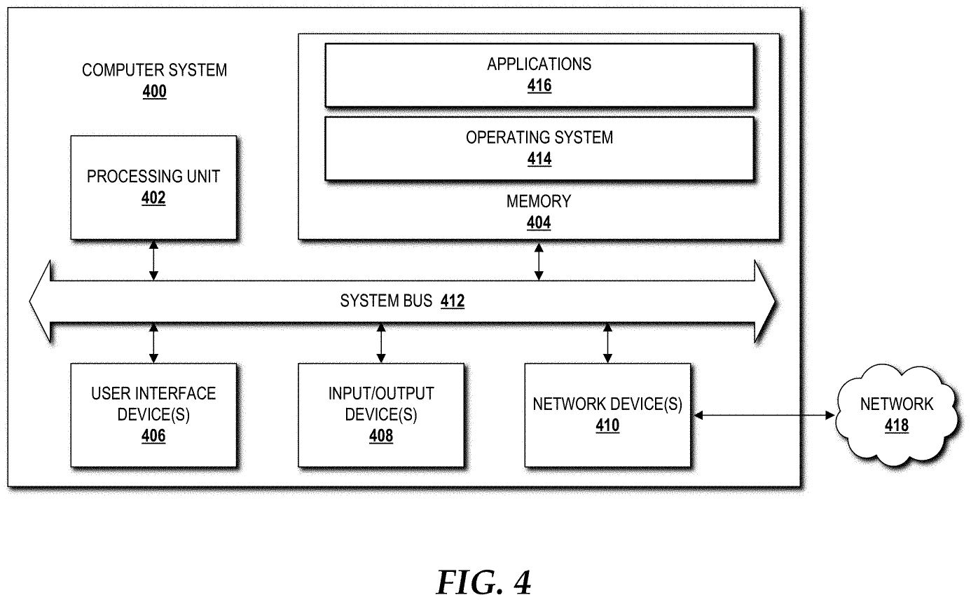

Turning now to FIG. 4, a block diagram illustrating a computer system 400 configured to provide the functionality described herein in accordance with various embodiments of the concepts and technologies disclosed herein will be described. In some embodiments, one or more of the devices 102, one or more of the RAN elements 110, one or more of the transport network elements 114, one or more of the core network elements, one or more of the application servers 120, the slicing security management system 123, one or more of the process aggregators 134, one or more components thereof, and/or other systems/platforms/devices/elements disclosed herein can be configured like and/or can have an architecture similar or identical to the computer system 400 described herein with respect to FIG. 4. It should be understood, however, that any of these systems, devices, platforms, or elements may or may not include the functionality described herein with reference to FIG. 4.

The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the computer system 400.

The memory 404 communicates with the processing unit 402 via the system bus 412. In some embodiments, the memory 404 is operatively connected to a memory controller (not shown) that enables communication with the processing unit 402 via the system bus 412. The memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 416 can include various software, program modules, and/or databases described herein. For example, the program modules 416 can include the applications 104, software utilized by the RAN elements 110, software utilized by the transport network elements 114, software utilized by the core network elements, software utilized by the application servers 120, software utilized by the slicing security management system 123, and/or software utilized by the process aggregators 134. The memory 404 also can store sub slice information, security credentials, and/or other data described herein.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media, and therefore should be construed as being directed to “non-transitory” media only.

The user interface devices 406 may include one or more devices with which a user accesses the computer system 400. The user interface devices 406 may include, but are not limited to, computers, servers, personal digital assistants, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer to output data.

The network devices 410 enable the computer system 400 to communicate with other networks or remote systems via one or more networks, such as the mobile telecommunications network 106, the RAN 108, the transport network 112, and/or the core network 116. Examples of the network devices 410 include, but are not limited to, a modem, a RF or infrared (“IR”) transceiver, a telephonic interface, a bridge, a router, or a network card. The network(s) may include a wireless network such as, but not limited to, a WLAN such as a WI-FI network, a WWAN, a Wireless Personal Area Network (“WPAN”) such as BLUETOOTH, a Wireless Metropolitan Area Network (“WMAN”) such as a Worldwide Interoperability for Microwave Access (“WiMAX”) network, or a cellular network. Alternatively, the network(s) may be a wired network such as, but not limited to, a WAN such as the Internet, a LAN, a wired PAN, or a wired MAN.

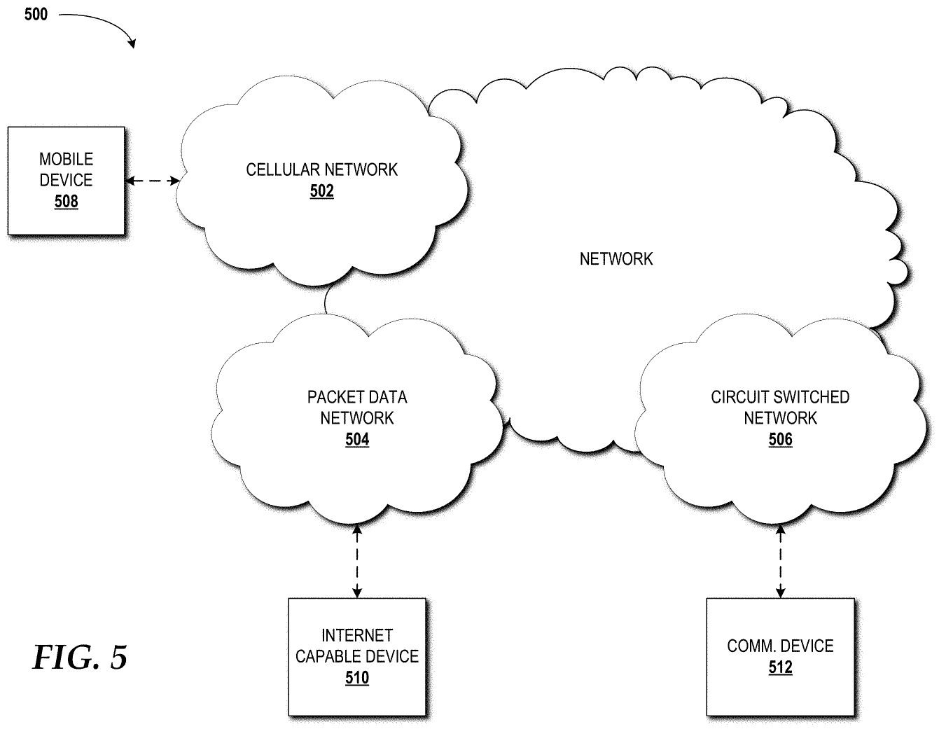

Turning now to FIG. 5, additional details of an embodiment of a network 500 will be described, according to an illustrative embodiment. In the illustrated embodiment, the network 500 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), HSSs, visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506. The cellular network 502 can be or can include the mobile telecommunications network 106.

A mobile communications device 508, such as, for example, a cellular telephone, a user equipment, a mobile terminal, a PDA, a laptop computer, a handheld computer, and combinations thereof, can be operatively connected to the cellular network 502. In some embodiments, the mobile communications device 508 can be or can include the device 102. The cellular network 502 can be configured to utilize any using any wireless communications technology or combination of wireless communications technologies, some examples of which include, but are not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The mobile communications device 508 can communicate with the cellular network 502 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged between the mobile communications device 508 and the cellular network 502 via cellular data technologies such as, but not limited to, GPRS, EDGE, the HSPA protocol family including General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, 5G technologies, and/or various other current and future wireless data access technologies. It should be understood that the cellular network 502 may additionally include backbone infrastructure that operates on wired communications technologies, including, but not limited to, optical fiber, coaxial cable, twisted pair cable, and the like to transfer data between various systems operating on or in communication with the cellular network 502.

The packet data network 504 can include various systems/platforms/devices, such as, for example, servers, computers, databases, and other systems/platforms/devices, in communication with one another. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet.

The circuit switched network 506 includes various hardware and software for providing circuit switched communications. The circuit switched network 506 may include, or may be, what is often referred to as a plain old telephone system (“POTS”). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable systems/devices 510, for example, a personal computer (“PC”), a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. It should be appreciated that substantially all of the functionality described with reference to the network 500 can be performed by the cellular network 502, the packet data network 504, and/or the circuit switched network 506, alone or in combination with additional and/or alternative networks, network elements, and the like.

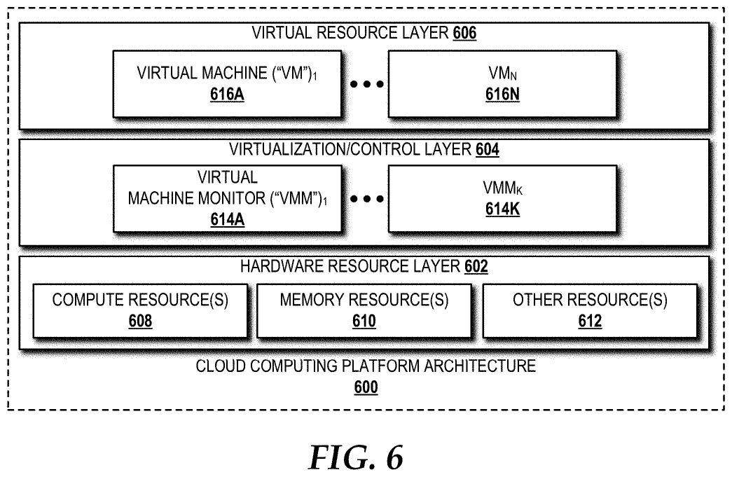

Turning now to FIG. 6, a cloud computing platform architecture 600 capable of implementing aspects of the concepts and technologies disclosed herein will be described, according to an illustrative embodiment. In some embodiments, one or more of the devices 102, one or more of the RAN elements 110, one or more of the transport network elements 114, one or more of the core network elements 118, one or more of the application servers 120, the slicing security management system 123, one or more of the process aggregators 134, one or more components thereof, can be implemented, at least in part, on the cloud computing platform architecture 600. Those skilled in the art will appreciate that the illustrated cloud computing platform architecture 600 is a simplification of but one possible implementation of an illustrative cloud computing platform, and as such, the cloud computing platform architecture 600 should not be construed as limiting in any way.

The illustrated cloud computing platform architecture 600 includes a hardware resource layer 602, a virtualization/control layer 604, and a virtual resource layer 606 that work together to perform operations as will be described in detail herein. While connections are shown between some of the components illustrated in FIG. 6, it should be understood that some, none, or all of the components illustrated in FIG. 6 can be configured to interact with one other to carry out various functions described herein. In some embodiments, the components are arranged so as to communicate via one or more networks (not shown). Thus, it should be understood that FIG. 6 and the following description are intended to provide a general understanding of a suitable environment in which various aspects of embodiments can be implemented, and should not be construed as being limiting in any way.

The hardware resource layer 602 provides hardware resources, which, in the illustrated embodiment, include one or more compute resources 608, one or more memory resources 610, and one or more other resources 612. The compute resource(s) 606 can include one or more hardware components that perform computations to process data, and/or to execute computer-executable instructions of one or more application programs, operating systems, and/or other software. The compute resources 608 can include one or more central processing units (“CPUs”) configured with one or more processing cores. The compute resources 608 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 608 can include one or more discrete GPUs. In some other embodiments, the compute resources 608 can include CPU and GPU components that are configured in accordance with a co-processing CPU/GPU computing model, wherein the sequential part of an application executes on the CPU and the computationally-intensive part is accelerated by the GPU. The compute resources 608 can include one or more system-on-chip (“SoC”) components along with one or more other components, including, for example, one or more of the memory resources 610, and/or one or more of the other resources 612. In some embodiments, the compute resources 608 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 608 can be or can include one or more hardware components architected in accordance with an ARM architecture, available for license from ARM HOLDINGS of Cambridge, United Kingdom. Alternatively, the compute resources 608 can be or can include one or more hardware components architected in accordance with an x86 architecture, such an architecture available from INTEL CORPORATION of Mountain View, Calif., and others. Those skilled in the art will appreciate the implementation of the compute resources 608 can utilize various computation architectures, and as such, the compute resources 608 should not be construed as being limited to any particular computation architecture or combination of computation architectures, including those explicitly disclosed herein.

The memory resource(s) 610 can include one or more hardware components that perform storage operations, including temporary or permanent storage operations. In some embodiments, the memory resource(s) 610 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 608.

The other resource(s) 612 can include any other hardware resources that can be utilized by the compute resources(s) 606 and/or the memory resource(s) 610 to perform operations. The other resource(s) 612 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 602 can be virtualized by one or more virtual machine monitors (“VMMs”) 614A-614K (also known as “hypervisors”; hereinafter “VMMs 614”) operating within the virtualization/control layer 604 to manage one or more virtual resources that reside in the virtual resource layer 606. The VMMs 614 can be or can include software, firmware, and/or hardware that alone or in combination with other software, firmware, and/or hardware, manages one or more virtual resources operating within the virtual resource layer 606.

The virtual resources operating within the virtual resource layer 606 can include abstractions of at least a portion of the compute resources 608, the memory resources 610, the other resources 612, or any combination thereof. These abstractions are referred to herein as virtual machines (“VMs”). In the illustrated embodiment, the virtual resource layer 606 includes VMs 616A-616N (hereinafter “VMs 616”).

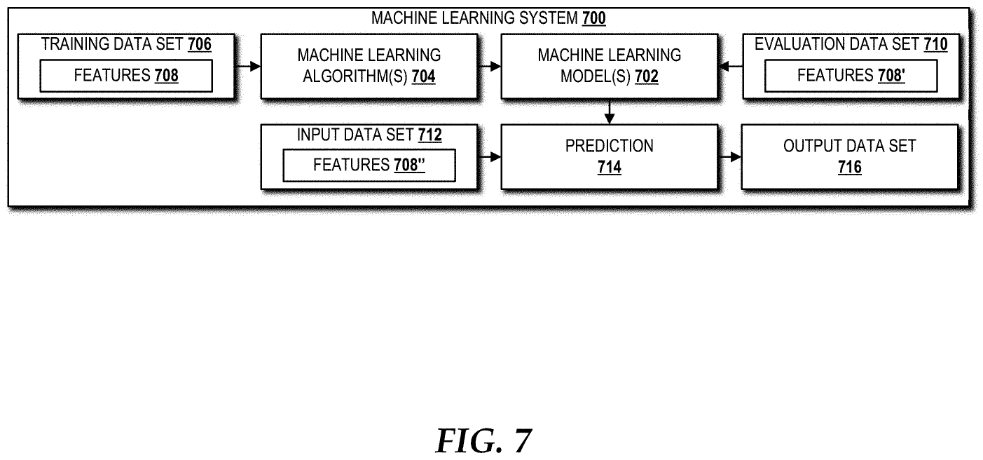

Turning now to FIG. 7, a machine learning system 700 capable of implementing aspects of the embodiments disclosed herein will be described. In some embodiments, one or more of the devices 102, one or more of the RAN elements 110, one or more of the transport network elements 114, one or more of the core network elements 118, one or more of the application servers 120, the slicing security management system 123, and/or one or more of the processor aggregators 134 can be configured to utilize the machine learning system 700. The illustrated machine learning system 700 includes one or more machine learning models 702. The machine learning models 702 can include supervised and/or semi-supervised learning models. The machine learning model(s) 702 can be created by the machine learning system 700 based upon one or more machine learning algorithms 704. The machine learning algorithm(s) 704 can be any existing, well-known algorithm, any proprietary algorithms, or any future machine learning algorithm. Some example machine learning algorithms 704 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 704 based upon the problem(s) to be solved by machine learning via the machine learning system 700.

The machine learning system 700 can control the creation of the machine learning models 702 via one or more training parameters. In some embodiments, the training parameters are selected modelers at the direction of an enterprise, for example. Alternatively, in some embodiments, the training parameters are automatically selected based upon data provided in one or more training data sets 706. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 704 converges to the optimal weights. The machine learning algorithm 704 can update the weights for every data example included in the training data set 706. The size of an update is controlled by the learning rate. A learning rate that is too high might prevent the machine learning algorithm 704 from converging to the optimal weights. A learning rate that is too low might result in the machine learning algorithm 704 requiring multiple training passes to converge to the optimal weights.

The model size is regulated by the number of input features (“features”) 706 in the training data set 706. A greater the number of features 708 yields a greater number of possible patterns that can be determined from the training data set 706. The model size should be selected to balance the resources (e.g., compute, memory, storage, etc.) needed for training and the predictive power of the resultant machine learning model 702.

The number of training passes indicates the number of training passes that the machine learning algorithm 704 makes over the training data set 706 during the training process. The number of training passes can be adjusted based, for example, on the size of the training data set 706, with larger training data sets being exposed to fewer training passes in consideration of time and/or resource utilization. The effectiveness of the resultant machine learning model 702 can be increased by multiple training passes.

Data shuffling is a training parameter designed to prevent the machine learning algorithm 704 from reaching false optimal weights due to the order in which data contained in the training data set 706 is processed. For example, data provided in rows and columns might be analyzed first row, second row, third row, etc., and thus an optimal weight might be obtained well before a full range of data has been considered. By data shuffling, the data contained in the training data set 706 can be analyzed more thoroughly and mitigate bias in the resultant machine learning model 702.

Regularization is a training parameter that helps to prevent the machine learning model 702 from memorizing training data from the training data set 706. In other words, the machine learning model 702 fits the training data set 706, but the predictive performance of the machine learning model 702 is not acceptable. Regularization helps the machine learning system 700 avoid this overfitting/memorization problem by adjusting extreme weight values of the features 708. For example, a feature that has a small weight value relative to the weight values of the other features in the training data set 706 can be adjusted to zero.

The machine learning system 700 can determine model accuracy after training by using one or more evaluation data sets 710 containing the same features 708′ as the features 708 in the training data set 706. This also prevents the machine learning model 702 from simply memorizing the data contained in the training data set 706. The number of evaluation passes made by the machine learning system 700 can be regulated by a target model accuracy that, when reached, ends the evaluation process and the machine learning model 702 is considered ready for deployment.

After deployment, the machine learning model 702 can perform a prediction operation (“prediction”) 714 with an input data set 712 having the same features 708″ as the features 708 in the training data set 706 and the features 708′ of the evaluation data set 710. The results of the prediction 714 are included in an output data set 716 consisting of predicted data. The machine learning model 702 can perform other operations, such as regression, classification, and others. As such, the example illustrated in FIG. 7 should not be construed as being limiting in any way.

Turning now to FIG. 8, an illustrative mobile device 800 and components thereof will be described. In some embodiments, one or more of the devices 102, one or more components thereof, is/are configured similar to or the same as the mobile device 800. While connections are not shown between the various components illustrated in FIG. 8, it should be understood that some, none, or all of the components illustrated in FIG. 8 can be configured to interact with one another to carry out various device functions. In some embodiments, the components are arranged so as to communicate via one or more busses (not shown). Thus, it should be understood that FIG. 8 and the following description are intended to provide a general understanding of a suitable environment in which various aspects of embodiments can be implemented, and should not be construed as being limiting in any way.

As illustrated in FIG. 8, the mobile device 800 can include a display 802 for displaying data. According to various embodiments, the display 802 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 800 also can include a processor 804 and a memory or other data storage device (“memory”) 806. The processor 804 can be configured to process data and/or can execute computer-executable instructions stored in the memory 806. The computer-executable instructions executed by the processor 804 can include, for example, an operating system 808, one or more applications 810, other computer-executable instructions stored in the memory 806, or the like. In some embodiments, the applications 810 also can include a UI application (not illustrated in FIG. 8).

The UI application can interface with the operating system 808 to facilitate user interaction with functionality and/or data stored at the mobile device 800 and/or stored elsewhere. In some embodiments, the operating system 808 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 804 to aid a user in entering/deleting data, entering and setting user IDs and passwords for device access, configuring settings, manipulating content and/or settings, multimode interaction, interacting with other applications 810, and otherwise facilitating user interaction with the operating system 808, the applications 810, and/or other types or instances of data 812 that can be stored at the mobile device 800.

The applications 810, the data 812, and/or portions thereof can be stored in the memory 806 and/or in a firmware 814, and can be executed by the processor 804. The firmware 814 also can store code for execution during device power up and power down operations. It can be appreciated that the firmware 814 can be stored in a volatile or non-volatile data storage device including, but not limited to, the memory 806 and/or a portion thereof.

The mobile device 800 also can include an input/output (“I/O”) interface 816. The I/O interface 816 can be configured to support the input/output of data such as location information, presence status information, user IDs, passwords, and application initiation (start-up) requests. In some embodiments, the I/O interface 816 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 800 can be configured to synchronize with another device to transfer content to and/or from the mobile device 800. In some embodiments, the mobile device 800 can be configured to receive updates to one or more of the applications 810 via the I/O interface 816, though this is not necessarily the case. In some embodiments, the I/O interface 816 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 816 may be used for communications between the mobile device 800 and a network device or local device.

The mobile device 800 also can include a communications component 818. The communications component 818 can be configured to interface with the processor 804 to facilitate wired and/or wireless communications with one or more networks, such as the mobile telecommunications network 106, the Internet, or some combination thereof. In some embodiments, the communications component 818 includes a multimode communications subsystem for facilitating communications via the cellular network and one or more other networks.

The communications component 818, in some embodiments, includes one or more transceivers. The one or more transceivers, if included, can be configured to communicate over the same and/or different wireless technology standards with respect to one another. For example, in some embodiments, one or more of the transceivers of the communications component 818 may be configured to communicate GSM, CDMA, CDMAONE, CDMA2000, LTE, and various other 2G, 2.5G, 3G, 4G, 4.5G, 5G, and greater generation technology standards. Moreover, the communications component 818 may facilitate communications over various channel access methods (which may or may not be used by the aforementioned standards) including, but not limited to, TDMA, FDMA, W-CDMA, OFDMA, SDMA, and the like.

In addition, the communications component 818 may facilitate data communications using GPRS, EDGE, the HSPA protocol family HSDPA, EUL (also referred to as HSUPA, HSPA+, and various other current and future wireless data access standards. In the illustrated embodiment, the communications component 818 can include a first transceiver (“TxRx”) 820A that can operate in a first communications mode (e.g., GSM). The communications component 818 also can include an Nth transceiver (“TxRx”) 820N that can operate in a second communications mode relative to the first transceiver 820A (e.g., UMTS). While two transceivers 820A-820N (hereinafter collectively and/or generically referred to as “transceivers 820”) are shown in FIG. 8, it should be appreciated that less than two, two, and/or more than two transceivers 820 can be included in the communications component 818.

The communications component 818 also can include an alternative transceiver (“Alt TxRx”) 822 for supporting other types and/or standards of communications. According to various contemplated embodiments, the alternative transceiver 822 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 818 also can facilitate reception from terrestrial radio networks, digital satellite radio networks, internet-based radio service networks, combinations thereof, and the like. The communications component 818 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 800 also can include one or more sensors 824. The sensors 824 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 800 may be provided by an audio I/O component 826. The audio I/O component 826 of the mobile device 800 can include one or more speakers for the output of audio signals, one or more microphones for the collection and/or input of audio signals, and/or other audio input and/or output devices.

The illustrated mobile device 800 also can include a subscriber identity module (“SIM”) system 828. The SIM system 828 can include a universal SIM (“USIM”), a universal integrated circuit card (“UICC”) and/or other identity devices. The SIM system 828 can include and/or can be connected to or inserted into an interface such as a slot interface 830. In some embodiments, the slot interface 830 can be configured to accept insertion of other identity cards or modules for accessing various types of networks. Additionally, or alternatively, the slot interface 830 can be configured to accept multiple subscriber identity cards. Because other devices and/or modules for identifying users and/or the mobile device 800 are contemplated, it should be understood that these embodiments are illustrative, and should not be construed as being limiting in any way.

The mobile device 800 also can include an image capture and processing system 832 (“image system”). The image system 832 can be configured to capture or otherwise obtain photos, videos, and/or other visual information. As such, the image system 832 can include cameras, lenses, charge-coupled devices (“CCDs”), combinations thereof, or the like. The mobile device 800 may also include a video system 834. The video system 834 can be configured to capture, process, record, modify, and/or store video content. Photos and videos obtained using the image system 832 and the video system 834, respectively, may be added as message content to an MMS message, email message, and sent to another device. The video and/or photo content also can be shared with other devices via various types of data transfers via wired and/or wireless communication devices as described herein.

The mobile device 800 also can include one or more location components 836. The location components 836 can be configured to send and/or receive signals to determine a geographic location of the mobile device 800. According to various embodiments, the location components 836 can send and/or receive signals from global positioning system (“GPS”) devices, assisted-GPS (“A-GPS”) devices, WI-FI/WIMAX and/or cellular network triangulation data, combinations thereof, and the like. The location component 836 also can be configured to communicate with the communications component 818 to retrieve triangulation data for determining a location of the mobile device 800. In some embodiments, the location component 836 can interface with cellular network nodes, telephone lines, satellites, location transmitters and/or beacons, wireless network transmitters and receivers, combinations thereof, and the like. In some embodiments, the location component 836 can include and/or can communicate with one or more of the sensors 824 such as a compass, an accelerometer, and/or a gyroscope to determine the orientation of the mobile device 800. Using the location component 836, the mobile device 800 can generate and/or receive data to identify its geographic location, or to transmit data used by other devices to determine the location of the mobile device 800. The location component 836 may include multiple components for determining the location and/or orientation of the mobile device 800.

The illustrated mobile device 800 also can include a power source 838. The power source 838 can include one or more batteries, power supplies, power cells, and/or other power subsystems including alternating current (“AC”) and/or direct current (“DC”) power devices. The power source 838 also can interface with an external power system or charging equipment via a power I/O component 840. Because the mobile device 800 can include additional and/or alternative components, the above embodiment should be understood as being illustrative of one possible operating environment for various embodiments of the concepts and technologies described herein. The described embodiment of the mobile device 800 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 800 or other devices or computers described herein, such as the computer system 400 described above with reference to FIG. 4. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 800 in order to store and execute the software components presented herein. It is also contemplated that the mobile device 800 may not include all of the components shown in FIG. 8, may include other components that are not explicitly shown in FIG. 8, or may utilize an architecture completely different than that shown in FIG. 8.

Based on the foregoing, it should be appreciated that concepts and technologies directed to network slicing security have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a slicing security management system comprising a processor, from an application executing on a device, a request to initiate a communications session between the application and an application server;
receiving, by the slicing security management system, information about the communications session; and
triggering, by the slicing security management system, separate notification flows to provide each element participating in the communications session with sub slices and security credentials to be used during the communications session.

2. The method of claim 1, wherein receiving, by the slicing security management system, the information about the communications session comprises receiving, by the slicing security management system, an application type of the application, an expected duration of the communications session, a sensitivity of the application, an expected traffic volume associated with the communications session, a latency requirement of the application, or a quality of service requirement.

3. The method of claim 2, wherein receiving, by the slicing security management system, the information about the communications session comprises receiving, by the slicing security management system, the information about the communications session from a radio access network or from the application server.

4. The method of claim 1, further comprising providing, by the slicing security management system, a radio access network and the application with a frequency range and the security credentials to be used for each of the sub slices.

5. The method of claim 4, further comprising:
instructing, by the slicing security management system, a transport network operating in communication with the radio access network to configure a first virtual private network router at a first edge between the radio access network and the transport network; and
instructing, by the slicing security management system, the transport network further operating in communication with a core network to configure a second virtual private network router at a second edge between the transport network and the core network.

6. The method of claim 5, wherein the first virtual private network router and the second virtual private network router provide a virtual private network tunnel for each of the sub slices.

7. The method of claim 5, further comprising instructing, by the slicing security management system, the core network to instantiate a virtual machine for each of the sub slices.

8. The method of claim 7, further comprising synchronizing, by the slicing security management system, the radio access network, the transport network, the core network, and the application server in preparation for conducting the communications session.

9. The method of claim 8, further comprising instructing, by the slicing security management system, the application to initiate the communications session.

10. A slicing security management system comprising:
a processor; and
a memory having instructions stored thereon that, when executed by the processor, cause the processor to perform operations comprising
receiving, from an application executing on a device, a request to initiate a communications session between the application and an application server,
receiving information about the communications session, and
triggering separate notification flows to provide each element participating in the communications session with sub slices and security credentials to be used during the communications session.

11. The slicing security management system of claim 10, wherein receiving the information about the communications session comprises receiving an application type of the application, an expected duration of the communications session, a sensitivity of the application, an expected traffic volume associated with the communications session, a latency requirement of the application, or a quality of service requirement.

12. The slicing security management system of claim 11, wherein receiving, by the slicing security management system, the information about the communications session comprises receiving the information about the communications session from a radio access network or from the application server.

13. The slicing security management system of claim 10, wherein the operations further comprise providing a radio access network and the application with a frequency range and the security credentials to be used for each of the sub slices.

14. The slicing security management system of claim 13, wherein the operations further comprise:
instructing a transport network operating in communication with the radio access network to configure a first virtual private network router at a first edge between the radio access network and the transport network, and
instructing the transport network further operating in communication with a core network to configure a second virtual private network router at a second edge between the transport network and the core network; and
wherein the first virtual private network router and the second virtual private network router provide a virtual private network tunnel for each of the sub slices.

15. The slicing security management system of claim 14, wherein the operations further comprise instructing the core network to instantiate a virtual machine for each of the sub slices.

16. The slicing security management system of claim 14, wherein the operations further comprise synchronizing the radio access network, the transport network, the core network, and the application server in preparation for conducting the communications session.

17. The slicing security management system of claim 16, wherein the operations further comprise instructing the application to initiate the communications session.

18. A computer-readable storage medium having computer-executable instructions stored thereon that, when executed by a processor of a system, cause the processor to perform operations comprising:
receiving, from an application executing on a device, a request to initiate a communications session between the application and an application server;
receiving information about the communications session;
triggering separate notification flows to provide each element participating in the communications session with sub slices and security credentials to be used during the communications session;
providing a radio access network and the application with a frequency range and the security credentials to be used for each of the sub slices;
instructing a transport network operating in communication with the radio access network to configure a first virtual private network router at a first edge between the radio access network and the transport network;
instructing the transport network further operating in communication with a core network to configure a second virtual private network router at a second edge between the transport network and the core network;
instructing the core network to instantiate a virtual machine for each of the sub slices;
synchronizing the radio access network, the transport network, the core network, and the application server in preparation for conducting the communications session; and
instructing the application to initiate the communications session.

19. The computer-readable storage medium of claim 18, wherein receiving the information about the communications session comprises receiving an application type of the application, an expected duration of the communications session, a sensitivity of the application, an expected traffic volume associated with the communications session, a latency requirement of the application, or a quality of service requirement.

20. The computer-readable storage medium of claim 19, wherein receiving the information about the communications session comprises receiving the information about the communications session from the radio access network or from the application server.
